(19) United States
(12) Patent Application Publication
(10) Pub. No.: US 2008/0296329 A1
(43) Pub. Date: Dec. 4, 2008

(54) Article Transportation Rack

(76) Inventor: Michael Guckes, Hilliard, OH (US)

Correspondence Address: FROST BROWN TODD, LLC, 2200 PNC CENTER, 201 E. FIFTH STREET, CINCINNATI, OH, 45202, US

(21) Appl. No.: 11/754,424

(22) Filed: May 29, 2007

(51) Int. Cl. B62J 11/00

(52) U.S. Cl. 224/412

(57) ABSTRACT

The invention is a transportation rack system mountable on a two-wheel vehicle, such as a bicycle. The transportation rack system is used to transport articles and may be well-suited for large loads, heavy loads, or both. The transportation rack system has a core rack structure mounted to the vehicle frame. Provided is a platform accessory that is detachably mounted to the core rack structure.

### FIELD OF THE INVENTION

The present invention relates, in general, to article carriers and, in particular, to a rack for carrying articles configured for attachment to a vehicle.

### BACKGROUND OF THE INVENTION

Numerous two-wheel vehicle racks exist in the art, mainly for motorcycles, mopeds, scooters, and bicycles. Regarding bicycles, racks for carrying various articles are generally mounted to the bicycle frame above a wheel. Such racks typically have a horizontal platform upon which articles can be positioned. Bicycle racks known in the art also have side supports for carrying conventional pannier bags or other storage containers on either or both sides of the bicycle. Bicycle racks known in the art include those with adaptable accessories for transporting specific articles, such as golf bags, surfboards, child seats, or baskets. Various examples of bicycle racks may be found in U.S. Pat. Nos. 6,227,556; 5,655,696; 5,603,440; 5,411,190; 5,340,003; 5,332,134; 5,090,717; 4,666,071; 4,383,625; 4,328,914; 4,154,382; 4,429,818; D342,473; and D278,699.

Although a number of bicycle rack variations exist, many bicycle racks are unable to handle article loads of substantial volume in an efficient and balanced manner. In particular, current bicycle racks may be poorly suited to retain both a large top article and large side pannier bags concomitantly. There may not be sufficient organization or efficient design of the rack to accommodate a large number of desirable articles. It would therefore be advantageous to provide a rack system for a vehicle configured to carry a large number of articles conveniently. It would be further advantageous to provide a rack system configured to carry a large top article in addition to side pannier bags.

If a rider does attach a large number of articles to a vehicle, such as by strapping several large bags to a two-wheeled bicycle, the bicycle may become unstable due to the uneven distribution of weight. An unbalanced ride may lead to a potentially dangerous condition for a rider and may also be less energy efficient for the rider. It would therefore be advantageous to provide a rack system configured to allow a number of bags to be carried at the same time with a substantially balanced weight distribution.

Yet another problem common to many bicycle racks is that, when loaded, they may interfere with a cyclist's pedaling motion, thereby creating a hazardous condition for the cyclist. An overloaded bicycle that interferes with a cyclist's motion can quickly become a hazardous vehicle. It would therefore be advantageous to provide a rack system that is configured to carry a number of articles in a manner that is unobtrusive to a rider.

Finally, current rack designs often require the use of tools to mount various accessories onto the bicycle. The requirement of specialized tools may create an inconvenience for the cyclist, thereby decreasing the utility of the rack and diminishing the cyclist's efficiency in completing even basic tasks like grocery shopping. It would therefore be advantageous to provide a rack system that increases a cyclist's efficiency by providing the easy attachment of various accessories.

Consequently, a need exists for improvements in the safety and utility of article carriers and, in particular, to rack systems for bicycles.

### SUMMARY OF THE INVENTION

Provided is an article carrier allowing a rider to transport various payloads having a large volume, large weight, or both, without compromising the stability of the vehicle or the rider's motion. In one version, the rack system is comprised of a structural member, a platform accessory detachably mounted to the structural member, and storage members detachably mounted to the structural member and/or platform accessory. While the invention is particularly well-adapted to bicycles, the invention may also be adapted for use with other two-wheel vehicles such as motorcycles, mopeds, scooters, and the like.

### BRIEF DESCRIPTION OF THE DRAWINGS

The accompanying drawings incorporated in and forming a part of the specification illustrate several aspects of the present invention, and together with the description serve to explain the principles of the invention; it being understood, however, that this invention is not limited to the precise arrangements shown. In the drawings, like reference numerals refer to like elements in the several views. In the drawings:

FIG. 1 is a side view of a combined bicycle and accessorized rack system.

FIG. 2 is a perspective view of the combined bicycle and accessorized rack system of FIG. 1.

FIG. 3 is a partial exploded view of the accessorized rack system of FIG. 1 showing the attachment of a storage member to the bicycle.

FIG. 4 is an exploded view of the rack system and platform accessory illustrated in FIG. 3.

FIG. 5 is a side view of the combined bicycle and rack system of FIG. 2, shown without storage members.

FIG. 6 is a top view of the combined bicycle and rack system of FIG. 5.

FIG. 7 is a perspective view of the platform accessory illustrated in FIG. 4.

FIG. 8 is a perspective view of the rack system of FIG. 1 having a top storage member attached thereto, where the rack system is further shown having customized attachment clips and storage hooks.

Reference will now be made in detail to various versions of the invention, an example of which is illustrated in the accompanying drawings.

### DETAILED DESCRIPTION OF EMBODIMENTS OF THE INVENTION

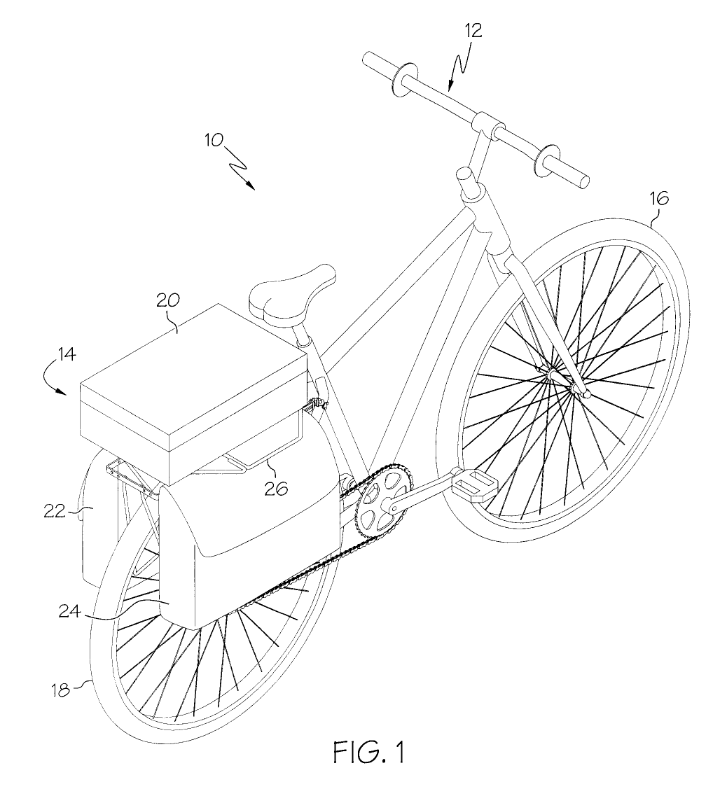

FIG. 1 references a merely illustrative version of the combined bicycle and rack system, indicated generally at 10. Combined bicycle and rack system 10 includes bicycle 12 and accessorized rack system 14. The combined bicycle and rack system 10 has a generally forward region 16 and generally rearward region 18. It will be appreciated that bicycle 12 may be any suitable two-wheel vehicle, for example, a mountain bike, road bike, moped, scooter, motorcycle, or the like.

The combined bicycle and rack system 10 may solve deficiencies of prior art two-wheel vehicle rack systems by enabling a rider to haul relatively large payloads, in terms of weight and volume, in a controlled and organized manner. More specifically, combined bicycle and rack system 10 may allow a rider to carry multiple pannier bags, side bags, or the like, on either side of the rack while also hauling a large article on top of the rack. Providing a rack system that is configured to carry both a large top article in addition to side pannier bags may be superior to prior art racks that inhibit a rider from carrying both side pannier bags and a large top article. In many such prior art devices the rack design causes the pannier bags to substantially interfere with the flat carrying surface of the rack. The combined bicycle and rack system 10 may allow a bicycle 12 or the like to be more heavily loaded and also loaded more compactly and efficiently. The compactness of the bicycle and rack system 10 may deliver the abovementioned benefits without compromising the stability, and thus the safety, of the vehicle or by restricting the motion of the rider.

In one version, accessorized rack system 14, as illustrated, is attached to the rearward region 18 of bicycle 12. It will be appreciated that in an alternate variation, accessorized rack system 14 may be attached to the forward region 16 of bicycle 12. Furthermore, multiple accessorized rack systems could be attached to both the forward and rearward regions of bicycle 12 for increased hauling capacity.

Still referring to FIG. 1, accessorized rack system 14, in one variation, is coupled to bicycle 12 in a detachable fashion. A detachable connection may be desirable so the rack system may be removed when not needed. This may be the case when a rider uses the bicycle, or the like, for multiple purposes such as leisure riding, competitive riding, or riding commercially to transport or deliver goods. Such a detachable coupling may be achieved mechanically, for example, by using clamps, brackets, bolts, or the like, by or any other suitable attachment mechanism or device. Such coupling may also be achieved, for example, with a magnetic connection, tie downs, an adhesive connection, or by any other suitable connection. In an alternate version, accessorized rack system 14 may be permanently attached to bicycle 12. Such permanent attachment may be achieved, for example, by welding or by integral construction with bicycle 12.

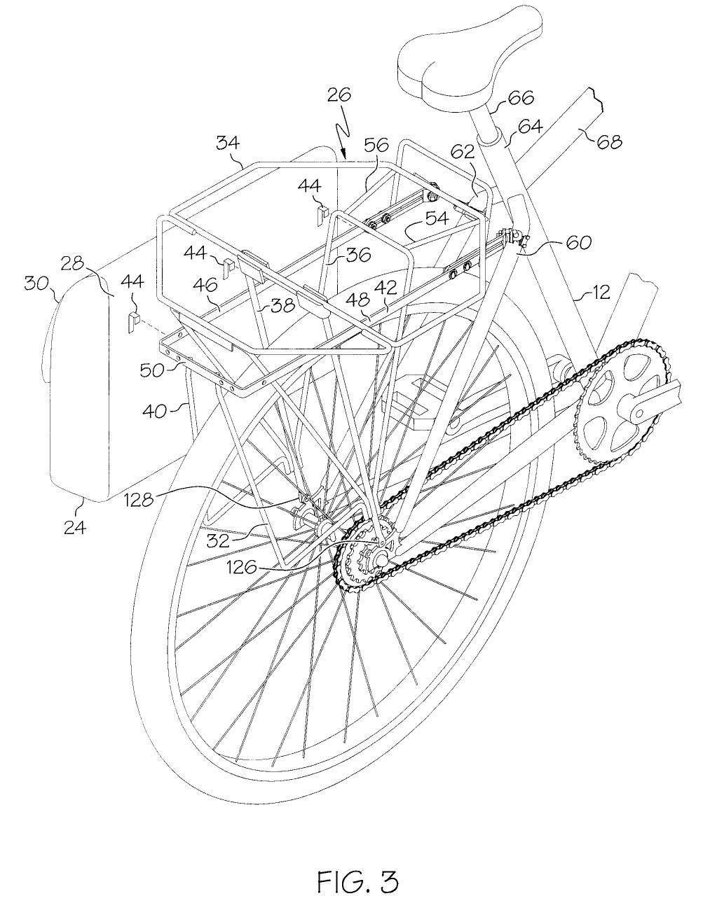

Referring to FIGS. 1-3, in one version, storage members 22, 24 are traditional pannier bags. Generally, the area of a traditional pannier bag that couples with a rack, herein referred to as attachment area 28, as illustrated in FIG. 3, is along the back portion of the bag, below the top portion or top flap 30 of the bag. With many prior art devices, the coupling between a standard pannier bag and the rack causes the pannier bag to protrude above the flat surface of the rack such that it interferes with the cyclist's ability to place an additional storage member on top of the rack. The design of rack system 26 allows traditional pannier bags, having an attachment area 28 located between the top and bottom of the bag, to be coupled with rack system 26 without inhibiting the addition of a top or first storage member 20. It will be appreciated that storage members 22, 24 may be one or several storage members of various designs other than traditional pannier bags including, for example, one or several backpacks, messenger bags, storage units, briefcases, bins, or any other suitable article, storage member, or accessory.

Storage member 20, in one version, as illustrated in FIGS. 1-3, is a container configured to associate with the top portion of rack system 26. It will be appreciated that storage member 20 may be any suitable container, article, or storage member such as, for example, a box, crate, bin, bag, case, trunk, or the like. It will be appreciated that storage member 20 may be represented by any suitable article such as sporting equipment of any suitable type, balls, one or a plurality of books, a toolbox, a folding chair, and/or any other article suitable for coupling with the top portion of rack system 26, or any suitable combination of articles.

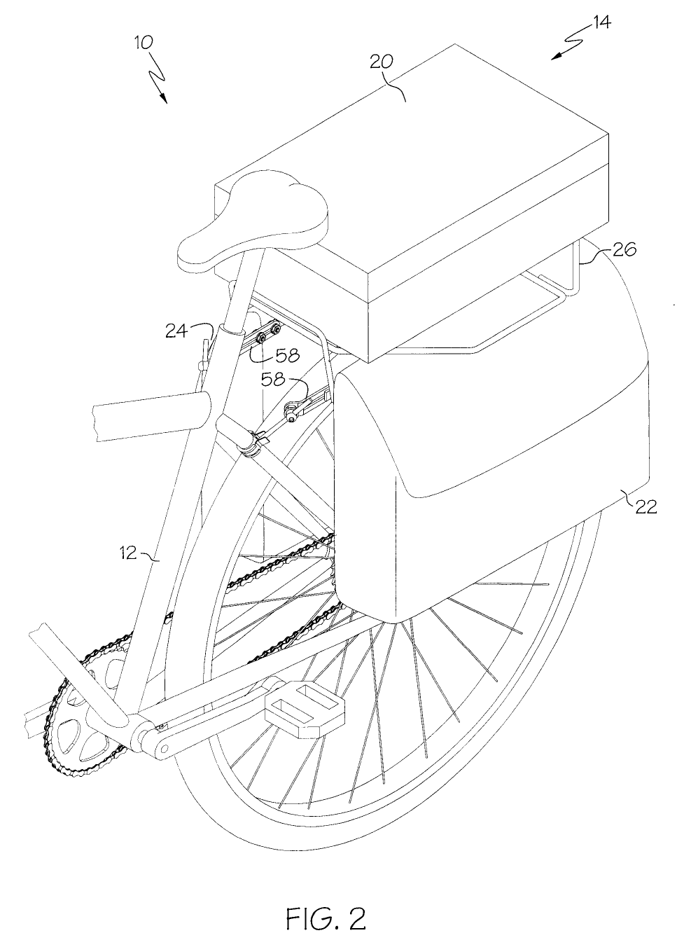

Referring again to FIGS. 1-2, one version of the rack system 26 is depicted shown with the first storage member 20 positioned on top of the rack system 26 and the storage member 22, 24 positioned on either side of the rack system 26. It will be appreciated that the coupling of storage members 20, 22, 24 with rack system 26 may take a myriad of configurations where, for example, storage member 22 may be attached to the rearward part of rack system 26 instead of to the side, and so forth. It will further be appreciated that rack system 26 may include any suitable number of storage members having any suitable shape, size, or configuration.

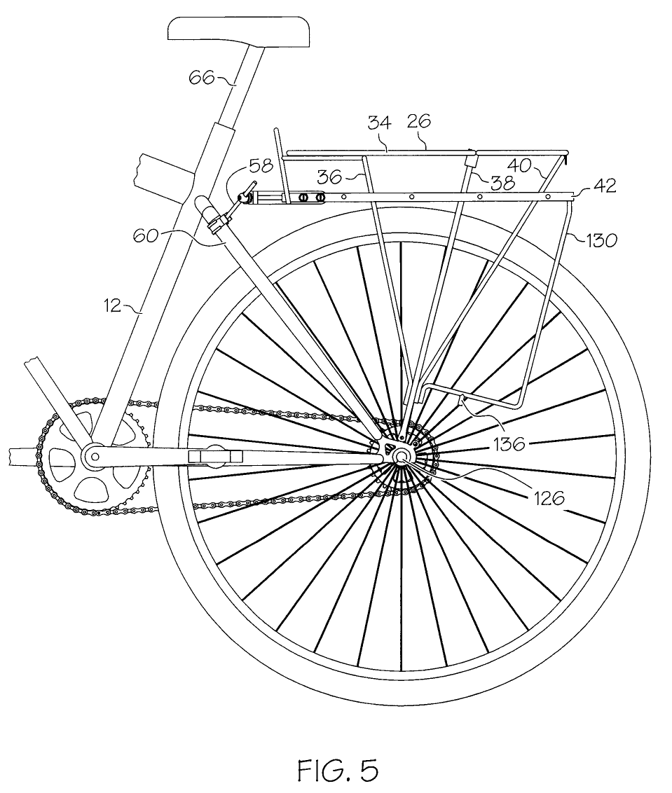

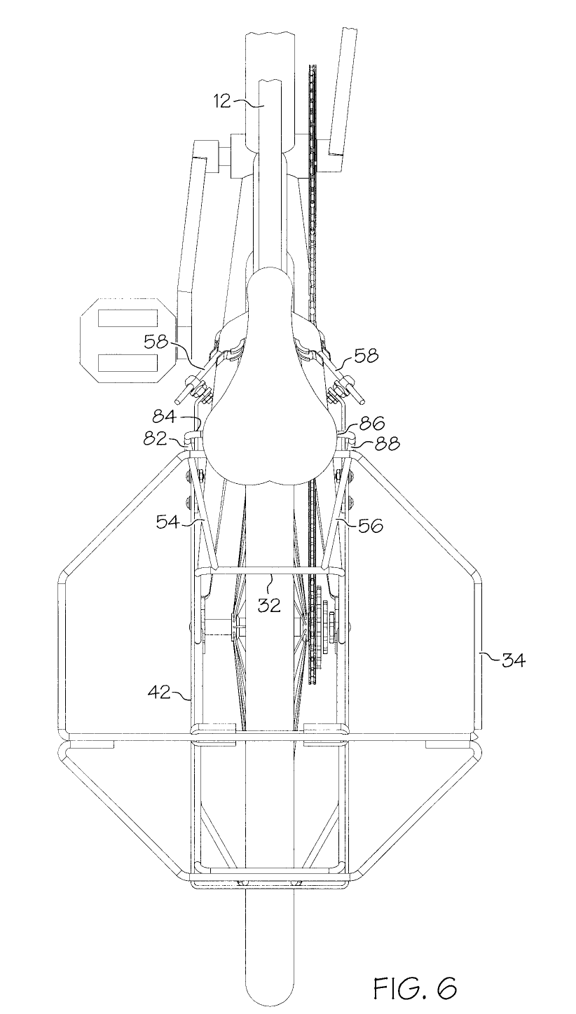

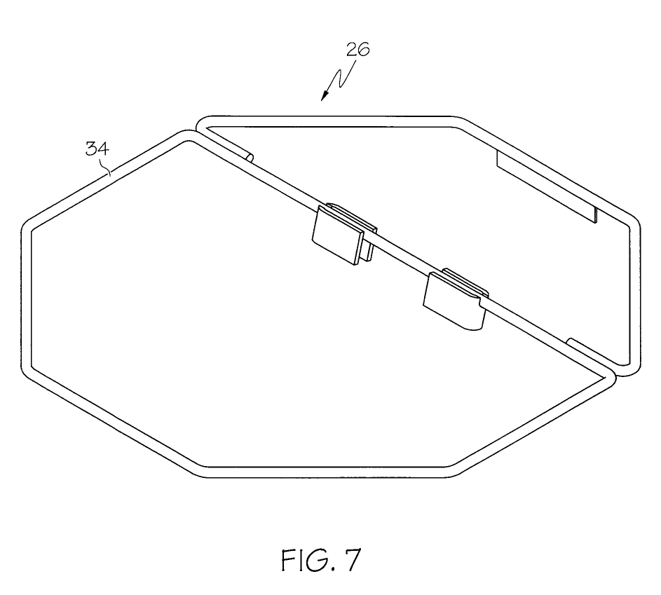

Referring to FIGS. 3-7, in one version, rack system 26 includes structural assembly 32 coupled with platform accessory 34. Platform accessory 34 may be permanently or detachably coupled to structural assembly 32. Depending on the use of the vehicle, the detachability of platform accessory 34 may allow the rider to configure rack system 26 such that the particular needs of the rider are met. For example, when use of the vehicle does not require holding a large number of articles, such as during a competitive race, the rider may elect to detach and store platform accessory 34. It will be appreciated that platform accessory 34 may be coupled with structural assembly 32 by any suitable device or method such as, for example, with clamps, bolts, brackets, screws, a hook and loop connection, adhesive, magnetism, ties, or any other suitable attachment mechanism, method, or device. In one version, platform accessory 34 is detachably coupled to structural assembly 32 using clamps with thumb screws. Such a coupling may be desirable as it allows for coupling and decoupling platform accessory 34 without the aid of tools, thereby saving labor and time.

In an alternate version, the platform accessory 34 is permanently coupled with structural assembly 32 by, for example, welding or integrally forming platform accessory 34 and structural assembly 32. A permanent coupling may be desirable when seeking maximum rigidity of rack system 26 for stability and safety.

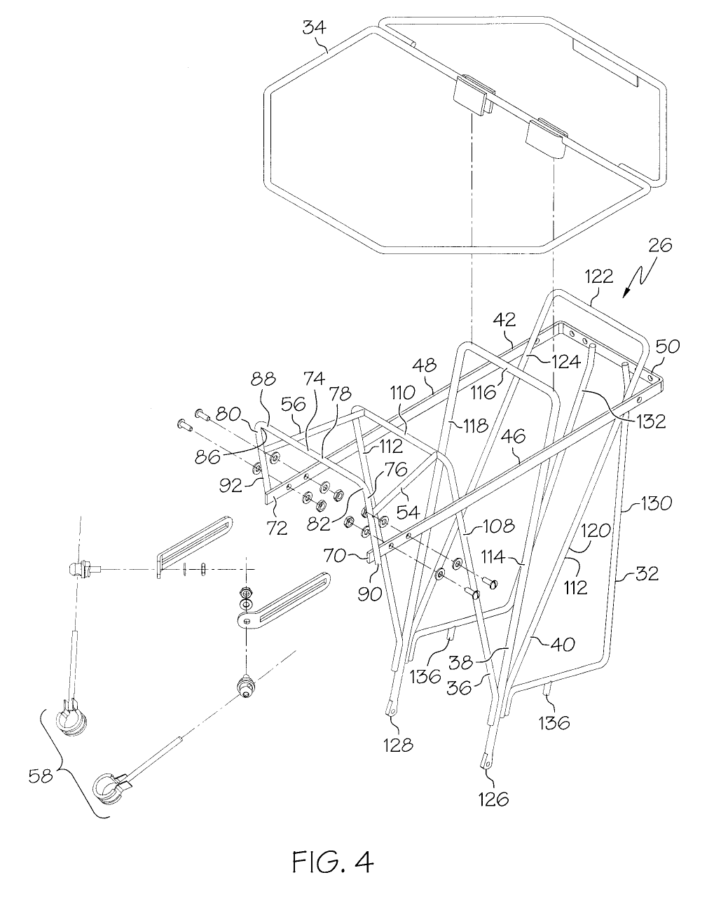

In one version, as illustrated in FIGS. 3-4, the platform accessory 34 is coupled to structural assembly 32 at the vertical structural members 36, 38, 40 of structural assembly 32. In one version, the vertical structural members 36, 38, 40 extend at least partially above the horizontal structural member 42 of structural assembly 32, thereby creating a void space between platform accessory 34 and horizontal structural member 42 when the platform accessory 34 is coupled with structural assembly 32. Coupling platform accessory 34 to the vertical structural members 36, 38, 40 above the horizontal structural member 42 enables the rack to haul or otherwise retain side mounted storage members and a top mounted storage member simultaneously in an efficient manner, as will be further discussed hereafter.

In alternate versions, it will be appreciated that platform accessory 34 may couple to structural assembly 32 at various connection points, or the like, that allow the platform accessory 34 to mount above horizontal structural member 42. For example, in one version, platform accessory 34 may couple with each vertical structural member 36, 38, 40, while in another version platform accessory 34 may only couple with vertical structural members 38, 40. It should be appreciated that any number of suitable coupling combinations may be achieved. The platform accessory 34, in the illustrated version, includes a shape with a plurality of sides. It should be appreciated that the platform accessory 34 may have any number of shapes, configurations, or sizes such as, for example, a square shape, a hexagon shape, a polyhedron shape, a pentagon shape, a circle, an octagon shape, and any other suitable geometry including combinations thereof.

Referring to FIG. 3, in one version storage members 22, 24 may be coupled to horizontal structural member 42. It should be appreciated that the coupling of storage members 22, 24 may be to other areas of structural assembly 32 such as, for example, at locations along the vertical structural members 36, 38, 40 including at the nipples 136. The coupling of storage members 22, 24 may be detachable or permanent. While detachable coupling provides the greatest flexibility to the rider, a permanent or integral coupling may provide a fixed storage system always accessible by a rider.

In one version, storage members 22, 24 may be detachably coupled to horizontal structural member 42 by using clips 44, or any other suitable attachment device or mechanism, that are affixed to the storage members 22, 24. The clips 44 may be configured to couple with the horizontal structural member 42 along the first horizontal structural member portion 46 and second horizontal structural member portion 48. It will be appreciated that the detachable coupling of storage members 22, 24 to structural assembly 32 may be achieved by other mechanisms or devices such as, for example, tie-downs, elastic rope, brackets, tongue and groove couplings, hook and loop couplings, tape, adhesive, and any other suitable mechanism or device including combinations thereof. Also, in another variation, storage members 22, 24 may be coupled with other portions of the horizontal structural member 42, for example, the coupling may be to the third horizontal structural member portion 50.

Referring to FIGS. 1-4, in one version, storage member 20 is coupled with platform accessory 34 such that, when coupled, storage member 20 is located generally on the top of rack system 26. In one version, storage member 20 may be coupled with platform accessory 34 by any suitable mechanism which securely associates storage member 20 with platform accessory 34. For example, storage member 20 may rest on top of platform accessory 34 and/or be secured by bungee cords, rope, tie-downs, or a combination thereof. In another version, storage member 20 may couple with platform accessory 34 with adhesive materials, hook and loop materials, clamps, hooks, clips, brackets, screws, a magnetic connection, or any other suitable device including combinations thereof.

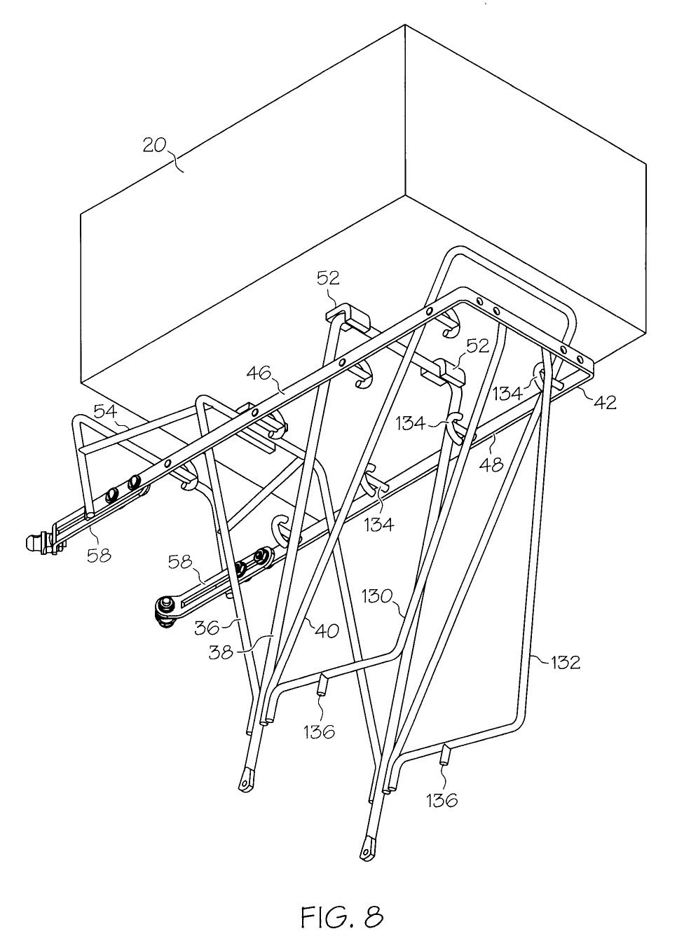

Referring to FIG. 8, in one version, storage member 20 may be coupled directly to structural assembly 32 when platform accessory 34 is not installed or otherwise associated with the structural assembly 32. In this version, storage member 20 may be coupled with vertical structural members 36, 38, 40. Storage member 20 may be detachably or permanently attached to vertical structural members 36, 38, 40. In one version, the detachable coupling may include J-hooks 52 which latch to the vertical structural members 36, 38, 40. It will be appreciated that any number of attachment mechanisms or devices may be suited to couple storage member 20 to structural assembly 32 when platform accessory 34 is not installed including, for example, clamps, brackets, screws, groove and slot, hook and loop, tape, adhesive, a magnetic connection, and any other suitable mechanism or device including combinations thereof. It will also be appreciated that in a version where platform accessory 34 is not installed, storage accessory 20 may be coupled with structural assembly 32 at points other than, or in addition to, vertical structural members 36, 38, 40. For example, storage member 20 may be coupled with vertical structural member 36 and connecting structural members 54, 56.

Referring to FIGS. 3-7, the illustrated version of rack system 26 includes structural assembly 32 and platform accessory 34. In one version, structural assembly 32 includes upper mounting member 58. In the illustrated version, upper mounting member 58 is coupled with bicycle 12 at each seat stay 60, 62. It will be further appreciated that upper mounting member 58 may be adjustable to fit any number of bicycle designs. It will also be appreciated that upper mounting member 58 may be adapted to couple to other parts of bicycle 12. For example, upper mounting member 58, shown in FIG. 3, may couple to the seat post 64, seat tube 66, top tube 68, or any other suitable location including combinations thereof. Furthermore, in the illustrated version, upper mounting member 58 couples to bicycle 12 by a mechanical clamp type connection. It will be appreciated that various other connecting mechanisms, such as brackets, bolts, magnets, hook and loop, adhesive, and the like, may be used to couple upper mounting member 58 bicycle 12.

In one version, the forward portion of upper mounting member 58 is coupled to bicycle 12 and the rearward portion of upper mounting member 58 is associated with structural assembly 32 at the horizontal structural member 42. It will be appreciated that upper mounting member 58 may be associated with structural assembly 32 at any number of locations.

In one version, horizontal structural member 42 includes first horizontal structural member portion 46, second horizontal structural member portion 48, and third horizontal structural member portion 50. In the illustrated version, upper mounting member 58 connects to horizontal structural member 42 at the first end 70 of horizontal structural member portion 46 and the first end 72 of second horizontal structural member portion 48. Upper mounting member 58 connects to horizontal structural member portions 46, 48 using a bolt and nut assembly. It will be appreciated that upper mounting member 58 may be connected to horizontal structural member portions 46, 48 by any other suitable mechanism, for example, welding, magnets, clamps, brackets, screws, other fasteners, adhesives, hook and look, and any combinations thereof.

In one version of structural assembly 32, a front structural member 74 is coupled with horizontal structural member portions 46, 48 near their respective first ends 70, 72. It will be appreciated that horizontal structural member 42 may include a fourth horizontal structural member portion to which front structural member 74 may couple. Front structural member 74 includes first front structural member portion 76, second front structural member portion 78, and third front structural member portion 80. Each front structural member portion 76, 78, 80 has a first end and second end. First end 82 of first front structural member portion 76 is associated with first end 84 of third front structural member portion 80. Second end 86 of third front structural member portion 80 is associated with first end 88 of second front structural member portion 78. The second end 90 of first front structural member portion 76 is coupled with first end 70 of first horizontal structural member portion 46. Similarly, the second end 92 of second front structural member portion 78 is coupled with first end 72 of second horizontal structural member portion 48. In the illustrated version, the resultant front structural member 74 is substantially U-shaped. It will be appreciated that the front structural member 74 may be constructed as an assembly or as a unitary construction. A unitary construction may be desirable for rigidity and simplified manufacture. It will be appreciated that the association or coupling of front structural member portions 76, 78, 80 to one another or to other parts of structural assembly 32 may be accomplished by a variety of mechanisms or devices including, for example, welding, screws, clamps, bolts, magnetic connection, adhesive, any other suitable fastening mechanism, and combinations thereof.

Referring again to FIGS. 3-7, the horizontal structural member 42 includes horizontal structural member portions 46, 48, 50. The horizontal structural member portions 46, 48, 50 may be substantially horizontal, which includes horizontal, at about horizontal, longitudinal, or projecting in a generally forward or rearward direction with respect to the vehicle. Each horizontal structural member portion includes a first end and second end and may have any of a number of configurations, for example, a triangle, pentagon, hexagon, three-sided U-shape, polygon, and any other suitable configuration. The term horizontal includes substantially horizontal, angled, or any other suitable geometry. It will also be appreciated that portions of the horizontal structural members may be vertical or angled in orientation.

Continuing to refer to FIGS. 3-7, structural assembly 32 includes vertical structural members 36, 38, 40. The vertical structural members may be substantially vertical, which includes vertical, at about vertical, projecting generally upward, or other suitable configurations. First vertical structural member 36 includes a first vertical structural member portion 108, second vertical structural member portion 110, and third vertical structural member portion 112. Second vertical structural member 38 includes a first vertical structural member portion 114, second vertical structural member portion 116, and third vertical structural member portion 118. Third vertical structural member portion 40 includes a first vertical structural member portion 120, second vertical structural member portion 122, and third vertical structural member portion 124. In one version, the vertical structural member portions 108, 110, 112, 114, 116, 118, 120, 122, 124 of the vertical structural members 36, 38, 40 are coupled in a configuration as shown in FIG. 3. It will be appreciated that the vertical structural members 36, 38, 40 may be constructed as an assembly or from a unitary piece of bent or shaped material.

Referring to FIGS. 3-6, in one version, vertical structural members 36, 38, 40 may be coupled with horizontal structural member 42. In the illustrated version, the coupling is configured such that at least a portion of the upper most portions of the vertical structural members rise above the horizontal structural member 42. Providing vertical members that project upwardly from a horizontal structural may allow for side bags having a vertically projecting portion above where they attach to fit comfortably into the rack. When the side bags are securely placed, the structural assembly 42 may be configured to comfortably accept a top article or storage member.

The vertical structural members 36, 38, 40 may be coupled to the horizontal structural member 42 as illustrated in FIG. 3. It will be appreciated that the coupling may be achieved through clamps, brackets, welding, ties, screws, bolts, and any other suitable mechanism or device including combinations thereof. In an alternate version, the vertical structural members 36, 38, 40 may rise above the horizontal structural member 42 without being directly coupled to horizontal structural member 42.

The vertical structural members 36, 38, 40, as illustrated in FIGS. 3-5, extend above horizontal structural member 42 and below horizontal structural member 42 such that horizontal structural member 42 is at a midpoint along the vertical structural members 36, 38, 40. The term midpoint refers to, for example, any point between the ends of the vertical structural members, a true midpoint, at about the true midpoint, from about one inch to about seven inches from the true midpoint, from about two inches to about five inches from the true midpoint, at about one to about eight inches above the true midpoint, at about two to about five inches above the true midpoint, at about the top third of the structural member, at about two to about four inches below the top of the support structure, or any other suitable configuration. The lower extending portions of vertical structural members 36, 38, 40 secure to a first lower mounting member 126 on one side of bicycle 12 and a second lower mounting member 128 on the opposite side of bicycle 12. Securing the vertical structural members is desirable so that the vertical structural members can effectively transfer the weight of the accessorized rack system 14 to bicycle 12, and so that the vertical structural members can protect the side storage members from striking or interfering with bicycle 12.

Referring to FIGS. 1-6, it will be appreciated that lower mounting members 126, 128 may be any suitable securing mechanism which couples the vertical structural member to bicycle 12, for example, by associating the lower mounting members with the bicycle frame eyelets, axle, seat stays, chain stays, or any other suitable portion of bicycle 12.

In one version, structural assembly 32 includes first rear structural member 130 and second rear structural member 132. Rear structural members 130, 132 may be configured to associate with horizontal structural member 42 and lower mounting members 126, 128 as illustrated in FIGS. 3-5. Rear support members 130, 132 may be desirable in applications that emphasize protecting the side storage members from interfering with bicycle 12 or maximizing rigidity when hauling or storing articles. The structural assembly may include one or a plurality of rear support members 130, 132. Rear support members 130, 132 may be a unitary construction having, for example, a generally u-shaped configuration.

Referring to FIG. 8, in one version, horizontal structural member 42 is provided with storage hooks 134 or any other suitable retainer. Storage hooks 134 may, for example, be detachably coupled to horizontal structural member 42 or permanently connected to horizontal structural member 42. In one version, detachable and adjustable coupling is achieved by using a storage hook 134 configured to clip onto horizontal structural member portions 46, 48, 50. It will be appreciated that an adjustable and detachable configuration may be achieved by any other suitable mechanism such as, for example, with adhesive, magnets, screws, or any other suitable fastening mechanism or device including combinations thereof. It will be appreciated that the storage hooks 134 may attach to the horizontal structural member 42, or any other suitable component, in any suitable manner including, for example, an integral connection, a unitary construction, passing through the horizontal member, clipping onto the horizontal member, clasping the horizontal member, resting upon the horizontal member, or the like. It will further be appreciated that storage hooks 134 may be constructed in a variety of ways and assume a variety of shapes and sizes. The storage hooks 134 may be desirable because they allow a cyclist to quickly associate a handled bag with the rack system 26. The storage hooks 134 may further increase the capacity of the rack beyond side storage members and top article.

In summary, numerous benefits have been described which result from employing concepts of the invention. The foregoing description of one or more versions of the invention has been presented for purposes of illustration and description. It is not intended to be exhaustive or to limit the invention to the precise form disclosed. Obvious modifications or variations are possible in light of the above teachings. The one or more versions were chosen and described in order to best illustrate principles of the invention and its practical application to thereby enable one of ordinary skill in the art to utilize the invention in various versions and with various modifications as are suited to the particular use contemplated. It is intended that the scope of the invention be defined by the claims appended hereto.

What is claimed is:

1. A rack system comprising:
(a) a structural assembly mountable to a two-wheeled vehicle frame comprising:
(i) a first support member, wherein the first support member has a substantially horizontal configuration; and
(ii) a second support member, the second support member having a substantially vertical configuration, wherein the first support member is coupled to the second support member at about a midpoint of the second support member, wherein the first support member is configured to accept the attachment of at least one accessory.

2. The rack system of claim 1, wherein the midpoint is at about the true midpoint of the second support member.

3. The rack system of claim 1, wherein the midpoint is biased towards the top of the second support member.

4. The rack system of claim 1, wherein the midpoint is at about two inches to at about 8 inches above the true midpoint of the second support member.

5. The rack system of claim 1, wherein the at least one accessory is selected from the group consisting of a pannier bag, a plurality of pannier bags, a storage container, a plurality of storage containers, a reflective device, safety accessories, a safety flag, signage, and combinations thereof.

6. The rack system of claim 1, wherein the first support member is configured to accept the attachment of at least one accessory with an attachment selected from the group consisting of an adjustable hook, a removable hook, a clip, a suction cup, a magnetic connection, a hook and loop connection, an adhesive, a buckle, and combinations thereof.

7. The rack system of claim 1, further comprising a platform accessory, the platform accessory being configured for attachment to the second support member at about a vertical structural member portion, wherein the platform accessory is configured to accept the attachment of at least one accessory.

8. The rack system of claim 7, wherein the platform accessory is detachable from the second support member.

9. The rack system of claim 7, wherein the platform accessory is integral with the second support member.

10. The rack system of claim 7, wherein the platform accessory is configured to accept at least one accessory and the first support member is configured to accept at least one accessory simultaneously.

11. The rack system of claim 10, wherein the at least one accessory associated with the first support member is at least one pannier bag.

12. The rack system of claim 10, wherein the rack system includes a first pannier bag attached to the first support member on a first side, a second pannier bag attached to the first support member on a second side, and a storage container attached to the platform accessory.

13. The rack system of claim 1, wherein the second support member is detachably coupled to a bicycle frame.

14. A method comprising the steps of:
providing a vehicle having at least two wheels;
providing a rack system, the rack system comprising;
(i) a first support member, wherein the first support member has a substantially horizontal configuration; and
(ii) a second support member, the second support member having a substantially vertical configuration, wherein the first support member is coupled to the second support member at about a midpoint of the second support member, wherein the first support member is configured to accept the attachment of at least one accessory;
coupling the rack system with the vehicle; and
attaching at least one accessory to the first support member.

15. The method of claim 14, wherein the midpoint is biased towards the top of the second support member.

16. The method of claim 14, wherein the midpoint is at about two inches to at about 8 inches above the true midpoint of the second support member.

17. The method of claim 14, wherein the at least one accessory is selected from the group consisting of a pannier bag, a plurality of pannier bags, a storage container, a plurality of storage containers, a reflective device, safety accessories, a safety flag, signage, and combinations thereof.

18. The method of claim 14, further comprising the steps of:
providing a platform accessory;
coupling the platform accessory with the second support member; and
attaching at least one accessory to the platform accessory.

19. The method of claim 18, wherein the rack system includes a first pannier bag attached to the first support member on a first side, a second pannier bag attached to the first support member on a second side, and a storage container attached to the platform accessory.

20. The method of claim 19, wherein the first pannier bag and the second pannier bag are standard pannier bags and do not substantially interfere with the storage container when attached.
